(19) United States
(12) Patent Application Publication
(10) Pub. No.: US 2013/0007864 A1
(43) Pub. Date: Jan. 3, 2013

(54) SYSTEM AND METHOD FOR LOCATION-AWARE SOCIAL NETWORKING AUTHENTICATION

(75) Inventor: Mark James Puflea, Raleigh, NC (US)

(73) Assignee: nCommon LLC, Durham, NC (US)

(21) Appl. No.: 13/537,585

(22) Filed: Jun. 29, 2012

Related U.S. Application Data
(60) Provisional application No. 61/502,846, filed on Jun. 29, 2011.

(51) Int. Cl. H04L 9/32; G06F 21/00

(52) U.S. Cl. 726/7

(57) ABSTRACT

Disclosed herein are systems, methods, and non-transitory computer-readable storage media for performing authentication via social networking data. A system configured to perform the example method first receives a request for a security token from a requestor. The system identifies, for the request, an executor and a trustee from social network contacts of the requestor. The system generates a challenge question based on location history information common to the requestor, the executor, and the trustee. The system presents the challenge question to the executor and to the trustee. The system receives an executor response from the executor and a trustee response from the trustee, and when the executor response and the trustee response match, transmits the security token to the requestor.

### RELATED APPLICATIONS

This nonprovisional patent application claims priority to U.S. Provisional Patent Application No. 61/502,846, filed 29 Jun. 2011, the contents of which are herein incorporated by reference in their entirety.

### BACKGROUND

1. Technical Field

The present disclosure relates to authentication and more specifically to authenticating a user's identity based on input from social network users associated with the user directly or indirectly.

2. Introduction

An increasing number of software and hardware applications rely on or incorporate some form of user authentication. For example, many smartphones store and access private or sensitive data, and require authentication from the user to unlock, such as entering a password or personal identification number. Many such situations arise in which an application or system requires authentication of a user's identity.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for using social network content in authentication or as part of multifactor authentication. Also disclosed is a minimum instruction set computer design implemented using the Google AppEngine API, optionally as Java Servlets. Further disclosed is a social content addressing system for subnetting and bridging participants into n-tiered, social factor & geolocated ad-hoc networks. Any of these embodiments can incorporate or otherwise rely on an agent-based modeling protocol to use-case target social network activity and search-assisted advertising. The principles set forth herein are applicable to virtually any social network platform. The system can incorporate information from one or more social networks in authentication.

### BRIEF DESCRIPTION OF THE FIGURES

In order to describe the manner in which the above-recited and other advantages and features of the disclosure can be obtained, a more particular description of the principles briefly described above will be rendered by reference to specific embodiments thereof which are illustrated in the figures. Understanding that these drawings depict only exemplary embodiments of the disclosure and are not therefore to be considered to be limiting of its scope, the principles herein are described and explained with additional specificity and detail through the use of the figures in which:

FIG. 1 illustrates an example system embodiment;

FIG. 2 illustrates an example high level block diagram of an authentication component;

FIG. 3 illustrates an example system flow;

FIG. 4 illustrates a first example method embodiment; and

FIG. 5 illustrates a second example method embodiment.

### DETAILED DESCRIPTION

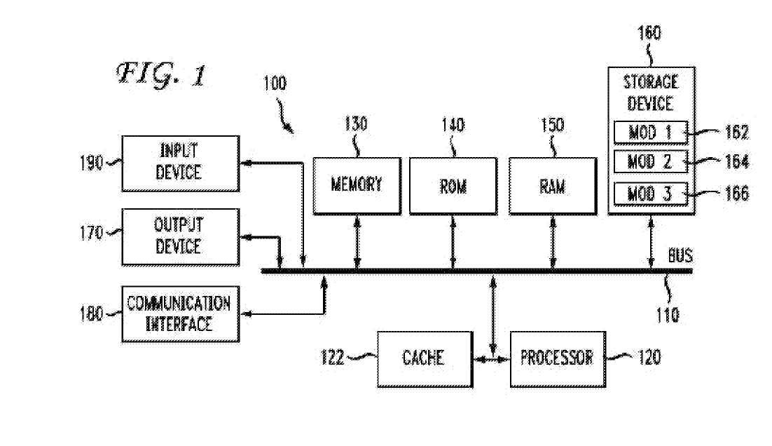

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. The disclosure now turns to FIG. 1.

With reference to FIG. 1, an exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache 122 of high speed memory connected directly with, in close proximity to, or integrated as part of the processor 120. The system 100 copies data from the memory 130 and/or the storage device 160 to the cache 122 for quick access by the processor 120. In this way, the cache provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored as would be known in the art in other computer-readable memory locations.

Having disclosed some components of a computing system, the disclosure now returns to a discussion of authentication via social networks. The principles set forth herein are applicable to virtually any social network platform, such as Facebook, LinkedIn, MySpace, as well as other social networks or equivalent technology platforms that provide sufficient access to contacts, relationships, and other data. The system can incorporate information from one or more social networks to perform authentication. For example, the system can perform authentication for a Facebook user using social networking data from LinkedIn. The authentication approaches set forth herein can be used as a primary authenticator, as a secondary authenticator, or as any other part of a multifactor authentication scheme.

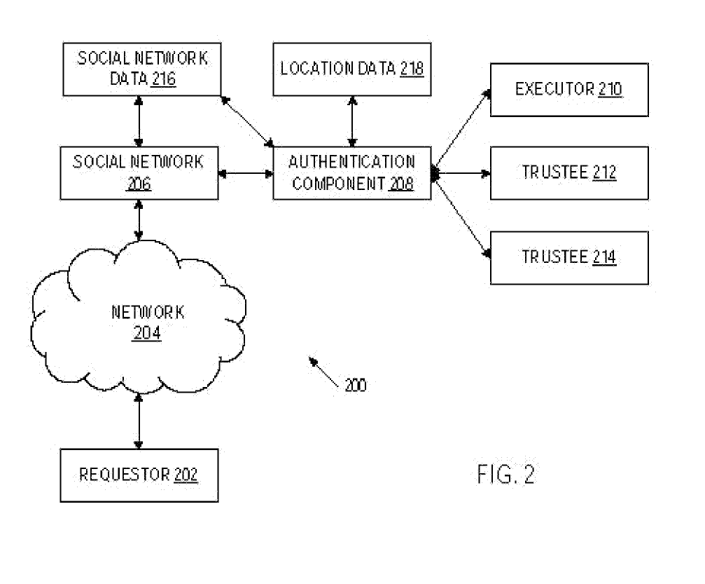

FIG. 2 illustrates an example high level block diagram of a social network architecture 200 incorporating an authentication component 208. A requestor 202 requests, via a communications network 204, a security token from a friend in a social network 206, known as the executor 210. An authentication component 208 processes the request on behalf of the social network 206, and passes the request to the executor 210. In one aspect, the executor 210 is a first order relation of the requestor 202. The authentication component 208 identifies trustees 212, 214, which may be first order relations to the executor based on social network data 216. The authentication component 208 can check with the trustees 212, 214 to ensure that they are available, have access to the appropriate compute and/or network resources, and so forth. The executor 210 receives the trustee responses and selects one or more trustees 212, 214 based on which trustees are available and willing to participate. The authentication component 208 initiates a search of geocoding histories or location data 218 for all participating trustees 212, 214, the executor 210, and/or the requestor 202. The authentication component 208 can identify and store common location data 218 and/or other social network data 216 for key generation. The authentication component 208 prompts the executor 210 and one or more trustee 212, 214 for a response to a challenge question, such as “Where were we last all together?,” with “we” meaning the requestor 202, the executor 210, and the respective one of the trustees 212, 214. This information should be straightforward for any of those users to remember, but can be next to impossible for an outsider or an attacker to guess.

In order to thwart attackers or malicious users, the authentication component 208 can analyze the location data 218 for regular patterns, such as a user going to the same location at the same time each week. A malicious user who is observant, could learn the typical behavior patterns for a target user, and impersonate the target user by guessing a likely answer to a location-based challenge question based on typical behavior patterns for that user. The authentication component 208 can flag regularly or habitually visited locations and ignore those when generating the challenge question. The authentication component 208 can generate a challenge question for the trustees 212, 214. The authentication component 208 transmits the challenge question or questions to the trustees, such as via email, text message, chat, social media, via an application, via a smartphone, etc. The trustees 212, 214 answer the challenge question and transmit a response back to the authentication component 208.

The authentication component 208 can communicate all responses and/or the appropriate location data in Executor mode. The authentication component can optionally impose restrictions so that the executor 210 sees the response, but not the contents of the response. In a non-blind variation, the executor 210 can see the contents of responses at any point after the responses have been provided by the trustees 212, 214.

An executor mode app can assign response-storage as shown below:

{

rand(n..n(participants)
alter array response; update index by rand( )
For Each response {

return(secret) to participant.n(byIndex)

}

}

Then the executor mode app can update trustee profiles by storing the response and optionally setting the response to private, then returning the object ID. The message executor can assign Trustee.n a value of complete ++uniqueObjectId(secret). Then the trustee applications exit, and the Executor2Recipient routine returns the Executor.tokenID. The authentication component 208 can store, for the requester, a tokenrequest.objectID and a randomly selected token from the trustee responses. Alternatively, the authentication component 208 can perform some other action when the identity of the requester 202 is authenticated.

Users, such as the requestor 202, executor 210, and trustees 212, 214, can interact with the authentication component 208 and/or the social network 206 via an electronic mobile device, a desktop computer, a tablet computing device, and so forth. The device can have access to a social networking service or to data generated by a social network service such as the social graph. The device can interact with the social network via an application programming interface (API) that allows programmatic queries of the social network graph and other social network data. The device can include an application or other interface to the authentication component 208. The device can interact with the social network to obtain unique indices for individual profile objects, and can be capable of setting public/private flags on individual objects.

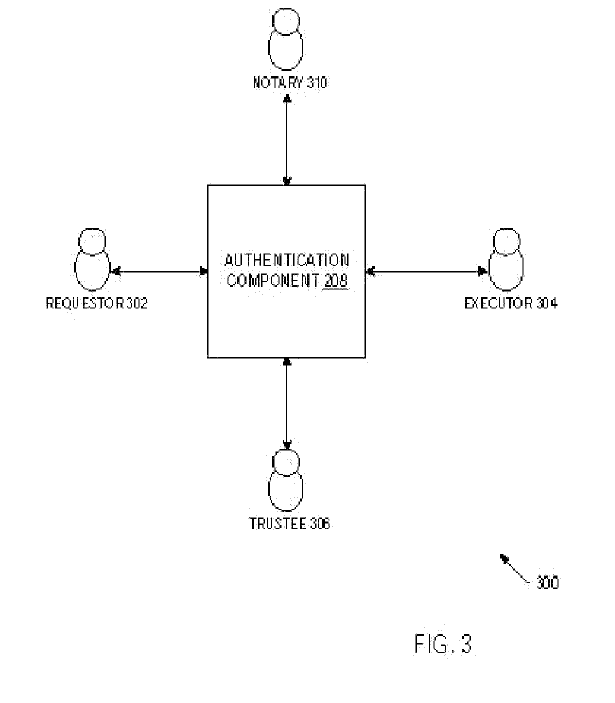

FIG. 3 illustrates an example architecture 300 for an authentication component 208 and a requestor 302, an executor 304, a trustee 306, and a notary 310. The requestor 302 initiates a request for authentication with the authentication component 208. The authentication component 208 selects an appropriate executor from the social graph of the requestor 302, and can verify that the executor 304 is available and willing to participate. The authentication component 208 can cycle through the social graph of the requestor 302 until an appropriate and willing executor 304 is located. If no available executor 304 is located, the authentication component 208 can fall back on other authentication approaches, can deny the request, or can provide an error message to the requestor 302 or ask the requestor 302 to try again later.

When a willing executor 304 is found, the authentication component 208 can generate a challenge to submit to the executor 304 and the trustee 306. The challenge-response can be a directed acyclic graph based on all or part of a user's social network data. In one example, the authentication component 208 generates a challenge in the form of a question based on common information between the executor 304 and the requestor 302 or the trustee 306 and the requestor 302. Then the executor 304 and the trustee 306 provide audio answers, for example, to the challenge. The authentication component 208 passes the audio answers to the notary 310, who can listen to the audio and match it with some baseline audio, which may be captured during an enrollment phrase in the authentication system.

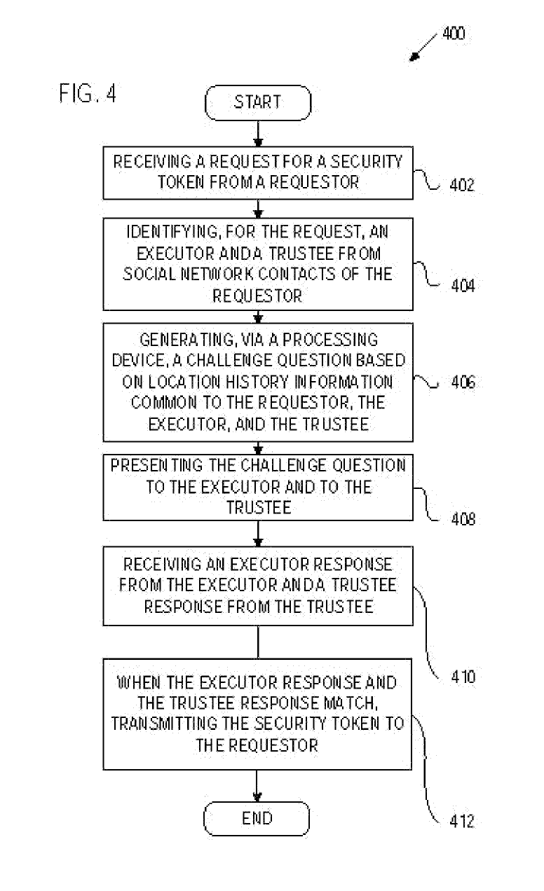

FIG. 4 illustrates a first example method embodiment 400. The method is discussed in terms of a system configured to practice the method. The system receives a request for a security token from a requestor (402). The requestor can submit the request directly via the social network, via an application operating within the social network, via an application on a smartphone or other computing device, and so forth. In some cases, the requestor submits the request directly, but the requestor can trigger the request via some other action. For example, the requestor can click a link to a resource requiring elevated permissions and/or authentication. As part of the request for that resource, a web browser, a web server, a social network, or some other entity can initiate the request for the security token. While this example is discussed in terms of a security token, the same principles can be applied to other security schemes that may not involve tokens and may rely on permissions to access resources for example.

The system identifies, for the request, an executor and a trustee from social network contacts of the requestor (404). For example, the system can identify the executor and/or the trustee from first order contacts of the requestor, or a more distant relation, such as second or third or higher order of contacts. A first order contact is someone who is directly connected in the social networking graph with the requestor. A second order contact is someone who is not connected directly to the requestor, but is connected to the requestor through someone else. Further, the system can identify a set of trustees, and present the set of trustees to the executor to select the trustee.

The system generates, such as via a processing device, a challenge question based on location history information common to the requestor, the executor, and the trustee (406). The system can identify the executor and/or the trustee based on the location history information. If the location history information does not provide any common point of reference for a given tuple of requestor, executor, and trustee, then the system can analyze the location history information to find a tuple for which a common point of reference exists. Similarly, the system can analyze the location history information to avoid selecting tuples which are too frequent, or which may be attended by more than a threshold number of other users to avoid the possibility of an unauthorized user providing the correct information in the authentication challenge question. In order to strengthen the authentication, the system can optionally generate the challenge question further based on social networking data of at least one of the requestor, the executor, and the trustee. The social networking data can include a social networking graph of social connections. In order to avoid authentication challenge questions which may be based on private, sensitive, embarrassing or other such information or events, users can mark portions of social networking data as public or private to authentication requests. Users can mark these portions manually in the social network or via the authentication component. Alternatively, a user can establish a set of rules that govern which portions of social networking data are visible and available to authentication challenge questions, and which portions are off limits. In one variation, if any user associated with a particular portion of social networking data marks it as private, then that information is not used for authentication purposes with any other users.

The system presents the challenge question to the executor and to the trustee (408) and receives an executor response from the executor and a trustee response from the trustee (410). The executor and the trustee can provide their response as text entered via a keyboard or as speech recorded and saved. However, the responses can take multiple forms, and can include audio, video, text, a gesture, an image, a date, a time, a direction, a number, a name, a price, and a color. In some variations, the system can present the trustee response to the executor prior to receiving the executor response. In this way, the executor may provide an indication that the trustee response is correct or agree with the response without explicitly providing a confirming response to match to the trustee response. This approach places a certain level of trust in the executor. Accordingly, the system can determine whether to allow the executor to simply agree with the trustee response based on factors indicating trustworthiness of the executor.

When the executor response and the trustee response match, the system transmits the security token to the requestor (412) or otherwise authorizes the request. Other examples of authorizing the request can include allowing access to a particular resource, elevating permissions for the requestor, or performing a requested action.

In one embodiment, a user requests access and the system identifies a connection in the user's social network with whom they have met with or otherwise interacted with recently. For example, a recent meeting or interaction can be within a threshold time in the past, such as within the past week or the past 3 days. The meeting or interaction can indicate a physical location or multiple physical locations in a particular order, such as visiting Best Buy, then Staples, then Office Depot. The meeting or interaction can optionally be a shared conference call or online interaction, where the location is not a physical location but a virtual location, such as a conference bridge, a URL, a chat room, a Facebook group, and so forth. The system asks that connection a location based social network question, that can include details of where and/or when the user and connection last met. The system can cross check the user's response against available data. Although this implementation provides strong security, it may be impractical for daily or frequent use if there be a delay finding a connection in a user's social graph that could respond immediately. Thus, this implementation may be suited to authenticate a user for situations that require a higher level of security, such as a large purchase, registering a new device for company email, joining a high security social group, setting up an online account for banking or other financial transactions, and so forth.

However, for more frequent use that does not require the same high degree of security or for uses in which an unnecessarily long delay would be cumbersome, the system can implement a “light” version of authentication that is simpler and faster, but provides a lesser degree of security. For example, the system can query the user requesting access and match the user's response with location based social network data stored by the system or available to the system. Example queries can include “where and when did you last see PERSON?”, where PERSON is someone that the user has seen within the history threshold. This “light” approach can offer an authentication experience that is faster, while still providing sufficient security for many applications, including certain enterprise applications. The system can incorporate or communicate with a security app on mobile devices. The security app can provide the system access to location based social network information, and can use work meetings or other calendar events as query items with the social network.

The non-light version could be used to authenticate more important or initial device usages, while the light version could be used for logging into company email from an outside device that is already registered. In this way, the system can provide security by using information that the user already knows, i.e. previous meetings with social network contacts, in such a way that a malicious user or an attacker would not be able to easily compromise the security scheme without following or otherwise monitoring the activities of the user and their social network contacts for a lengthy period of time in order to know the answers to the security questions.

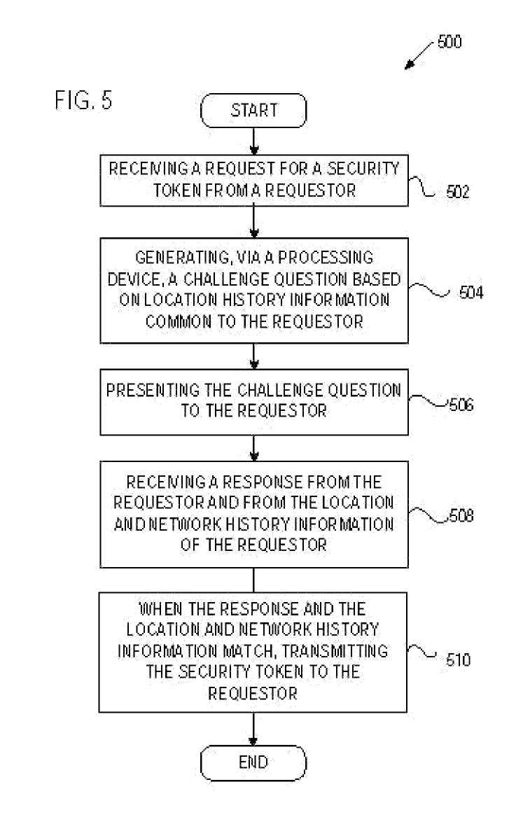

FIG. 5 illustrates a first example method embodiment 500 of the “light” variation for authentication that may provide expedited service of requests. The method is discussed in terms of a system configured to practice the method.

The system receives a request for a security token from a requestor (502). The requestor can submit the request directly via the social network, via an application operating within the social network, via an application on a smartphone or other computing device, and so forth. In some cases, the requestor submits the request directly, but the requestor can trigger the request via some other action. For example, the requestor can click a link to a resource requiring elevated permissions and/or authentication. As part of the request for that resource, a web browser, a web server, a social network, or some other entity can initiate the request for the security token. While this example is discussed in terms of a security token, the same principles can be applied to other security schemes that may not involve tokens and may rely on permissions to access resources for example.

The system generates, such as via a processing device, a challenge question based on location history information common to the requestor (504). The system presents the challenge question to the requestor (506) and receives a response from the requestor and from the location and network history information of the requestor (508). When the response and the location and network history match, the system transmits the security token to the requestor (512) or otherwise authorizes the request. Other examples of authorizing the request can include allowing access to a particular resource, elevating permissions for the requestor, or performing a requested action.

The system can allow an unlimited number of attempts for the user to respond to the question, or can set some limit on the number of guesses, especially where the universe of available response options is small. For example, the system can limit the number of tries a user gets to guess the correct response to the question, and can generate or send a report for failed attempts. Similarly, the data owner can log in to an interface, such as a web site, to view an audit trail for failed attempts.

The system can store keys to be used in authentication in others' social network profiles, such as in the trustee's profile or in the executor's profile. The keys can be stored in a dedicated ‘key’ field of the user's profile, or can be stored as specially formed data within an existing field of the user's profile. Users can serve multiple roles for different transactions. For example, a user may be a requestor for a first transaction, a notary in a second transaction, and a trustee in a third transaction.

The following table represents example data, values, and structures for information compression.

TABLE 1
The address scheme can be coded in 2 dimensions. The API can provide content compression.

| | | | Application | | | | | |
|---|---|---|---|---|---|---|---|---|
| Bit | | | Conversion | | | | | |
| Position | BinValue | HexValue | Content | B16Value | Represented | | | |
| | | | | | | | | Social Graph execution |
| 0 | 0 | 0 | 0-F | 16 | 0 = 0 | 1st-Octet | | range of messaging |
| | | | | | | | | Servlet |
| | | | | | | | | Status/acknowledgement |
| 1 | 1 | 1 | 0-F | 32 | 1 = 1 | 2nd-Octet | | range of messaging |
| | | | | | | | | graph registration range |
| 2 | 10 | 10 | 0-F | 48 | 2 = 2 | 3rd-Octet | | of messaging |
| | | | | | | | | Security execution range |
| 3 | 11 | 11 | 0-F | 64 | 3 = 3 | 4th-Octet | | of messaging |
| | | | | | | | | agent based model range |
| 4 | 100 | 100 | 0-F | 80 | 4 = 4 | | 5 | of messaging |
| 5 | 101 | 101 | 0-F | 96 | 5 = 5 | | 6 | unused |
| | | | | | | | | Mode/connect range of |
| 6 | 110 | 110 | 0-F | 112 | 6 = 6 | | 7 | messaging |
| 7 | 111 | 111 | 0-F | 128 | 7 = 7 | | 8 | unused |
| | | | | | | | | Payload datastream |
| | | | | | | | | supporting each |
| | | | | | | | | instruction call to servlet |
| 8 | 1000 | 1000 | Data | 144 | 8 = 8 | | | subsystems |
| 9 | 1001 | 1001 | | 160 | 9 = 9 | | | |
| 10 | 1010 | 10000 | | 176 | A = 10 | | | |
| 11 | 1011 | 10001 | | 192 | B = 11 | | | |
| 12 | 1100 | 10010 | | 208 | C = 12 | | | |
| 13 | 1101 | 10011 | | 224 | D = 13 | | | |
| 14 | 1110 | 10100 | | 240 | E = 14 | | | |
| 15 | 1111 | 10101 | | 256 | F = 15 | | | |
| 16 | 10000 | 10110 | | 272 | | | | |
| 17 | 10001 | 10111 | | 288 | | | | |
| 18 | 10010 | 11000 | | 304 | | | | |
| 19 | 10011 | 11001 | | 320 | | | | |
| 20 | 10100 | 100000 | | 336 | | | | |
| 21 | 10101 | 100001 | | 352 | | | | |
| 22 | 10110 | 100010 | | 368 | | | | |
| 23 | 10111 | 100011 | | 384 | | | | |
| 24 | 11000 | 100100 | | 400 | | | | |
| 25 | 11001 | 100101 | | 416 | | | | |
| 26 | 11010 | 100110 | | 432 | | | | |
| 27 | 11011 | 100111 | | 448 | | | | |
| 28 | 11100 | 101000 | | 464 | | | | |
| 29 | 11101 | 101001 | | 480 | | | | |
| 30 | 11110 | 110000 | | 496 | | | | |
| 31 | 11111 | 110001 | | 512 | | | | |
| 32 | 100000 | 110010 | | 528 | | | | |
| 33 | 100001 | 110011 | | 544 | | | | |
| 34 | 100010 | 110100 | | 560 | | | | |
| 35 | 100011 | 110101 | | 576 | | | | |
| 36 | 100100 | 110110 | | 592 | | | | |
| 37 | 100101 | 110111 | | 608 | | | | |
| 38 | 100110 | 111000 | | 624 | | | | |
| 39 | 100111 | 111001 | | 640 | | | | |
| 40 | 101000 | 1000000 | | 656 | | | | |
| 41 | 101001 | 1000001 | | 672 | | | | |
| 42 | 101010 | 1000010 | | 688 | | | | |
| 43 | 101011 | 1000011 | | 704 | | | | |
| 44 | 101100 | 1000100 | | 720 | | | | |
| 45 | 101101 | 1000101 | | 736 | | | | |
| 46 | 101110 | 1000110 | | 752 | | | | |
| 47 | 101111 | 1000111 | | 768 | | | | |
| 48 | 110000 | 1001000 | | 784 | | | | |
| 49 | 110001 | 1001001 | | 800 | | | | |
| 50 | 110010 | 1010000 | | 816 | | | | |
| 51 | 110011 | 1010001 | | 832 | | | | |
| 52 | 110100 | 1010010 | | 848 | | | | |
| 53 | 110101 | 1010011 | | 864 | | | | |
| 54 | 110110 | 1010100 | | 880 | | | | |
| 55 | 110111 | 1010101 | | 896 | | | | |
| 56 | 111000 | 1010110 | | 912 | | | | |
| 57 | 111001 | 1010111 | | 928 | | | | |
| 58 | 111010 | 1011000 | | 944 | | | | |
| 59 | 111011 | 1011001 | | 960 | | | | |
| 60 | 111100 | 1100000 | | 976 | | | | |
| 61 | 111101 | 1100001 | | 992 | | | | |
| 62 | 111110 | 1100010 | | 1008 | | | | |
| 63 | 111111 | 1100011 | | 1024 | | | | |
| 64 | 1000000 | 1100100 | | 1040 | | | | |
| 65 | 1000001 | 1100101 | | 1056 | | | | |
| 66 | 1000010 | 1100110 | | 1072 | | | | |
| 67 | 1000011 | 1100111 | | 1088 | | | | |
| 68 | 1000100 | 1101000 | | 1104 | | | | |
| 69 | 1000101 | 1101001 | | 1120 | | | | |
| 70 | 1000110 | 1110000 | | 1136 | | | | |
| 71 | 1000111 | 1110001 | | 1152 | | | | |
| 72 | 1001000 | 1110010 | | 1168 | | | | |
| 73 | 1001001 | 1110011 | | 1184 | | | | |
| 74 | 1001010 | 1110100 | | 1200 | | | | |
| 75 | 1001011 | 1110101 | | 1216 | | | | |
| 76 | 1001100 | 1110110 | | 1232 | | | | |
| 77 | 1001101 | 1110111 | | 1248 | | | | |
| 78 | 1001110 | 1111000 | | 1264 | | | | |
| 79 | 1001111 | 1111001 | | 1280 | | | | |
| 80 | 1010000 | 10000000 | | 1296 | | | | |
| 81 | 1010001 | 10000001 | | 1312 | | | | |
| 82 | 1010010 | 10000010 | | 1328 | | | | |
| 83 | 1010011 | 10000011 | | 1344 | | | | |
| 84 | 1010100 | 10000100 | | 1360 | | | | |
| 85 | 1010101 | 10000101 | | 1376 | | | | |
| 86 | 1010110 | 10000110 | | 1392 | | | | |
| 87 | 1010111 | 10000111 | | 1408 | | | | |
| 88 | 1011000 | 10001000 | | 1424 | | | | |
| 89 | 1011001 | 10001001 | | 1440 | | | | |
| 90 | 1011010 | 10010000 | | 1456 | | | | |
| 91 | 1011011 | 10010001 | | 1472 | | | | |
| 92 | 1011100 | 10010010 | | 1488 | | | | |
| 93 | 1011101 | 10010011 | | 1504 | | | | |
| 94 | 1011110 | 10010100 | | 1520 | | | | |
| 95 | 1011111 | 10010101 | | 1536 | | | | |
| 96 | 1100000 | 10010110 | | 1552 | | | | |
| 97 | 1100001 | 10010111 | | 1568 | | | | |
| 98 | 1100010 | 10011000 | | 1584 | | | | |
| 99 | 1100011 | 10011001 | | 1600 | | | | |
| 100 | 1100100 | 100000000 | | 1616 | | | | |
| 101 | 1100101 | 100000001 | | 1632 | | | | |
| 102 | 1100110 | 100000010 | | 1648 | | | | |
| 103 | 1100111 | 100000011 | | 1664 | | | | |
| 104 | 1101000 | 100000100 | | 1680 | | | | |
| 105 | 1101001 | 100000101 | | 1696 | | | | |
| 106 | 1101010 | 100000110 | | 1712 | | | | |
| 107 | 1101011 | 100000111 | | 1728 | | | | |
| 108 | 1101100 | 100001000 | | 1744 | | | | |
| 109 | 1101101 | 100001001 | | 1760 | | | | |
| 110 | 1101110 | 100010000 | | 1776 | | | | |
| 111 | 1101111 | 100010001 | | 1792 | | | | |
| 112 | 1110000 | 100010010 | | 1808 | | | | |
| 113 | 1110001 | 100010011 | | 1824 | | | | |
| 114 | 1110010 | 100010100 | | 1840 | | | | |
| 115 | 1110011 | 100010101 | | 1856 | | | | |
| 116 | 1110100 | 100010110 | | 1872 | | | | |
| 117 | 1110101 | 100010111 | | 1888 | | | | |
| 118 | 1110110 | 100011000 | | 1904 | | | | |
| 119 | 1110111 | 100011001 | | 1920 | | | | |
| 120 | 1111000 | 100100000 | | 1936 | | | | |
| 121 | 1111001 | 100100001 | | 1952 | | | | |
| 122 | 1111010 | 100100010 | | 1968 | | | | |
| 123 | 1111011 | 100100011 | | 1984 | | | | |
| 124 | 1111100 | 100100100 | | 2000 | | | | |
| 125 | 1111101 | 100100101 | | 2016 | | | | |
| 126 | 1111110 | 100100110 | | 2032 | | | | |
| 127 | 1111111 | 100100111 | | 2048 | | | | |
| 128 | 10000000 | 100101000 | | 2064 | | | | |

The following table illustrates an example data model and data structures behind command index and website operations.

TABLE 2

| nCommon Data model worksheet | |
|---|---|
| Purpose is to understand data structures behind the command index and website operations. | |
| | Every nCommon member user has a vertex and an |
| | associated heap. |
| | The vertex contains the pointer array to all profile content. |
| au profile contents | The heap contains the instance-specific exetion data |
| | processed by servlet activity initiated within a session. |
| InstructionBit | |

Payload

Item
ServiceMatrixKey - toplevel index for an nCommon useraccount (contains all instances of
use)

fieldname
ServiceMatrixKey

| | |
|---|---|
| Array_SampleNames | Mark Puflea, Wiley Becker, Troy |
| | Knaus, Greg Pool, David Letterman, |
| | Rhonda Whitney, Tom Collins, Walter |
| | Reed, Bunny Sherman, Lissi Marquis, |
| | Ed Jones, Billy Raye, Shelby Foote, |
| | Willy Wonka |

HEX(MarkufleaWileyBeckerTroyKnausGregPoolDavidLetterman
RhondaWhitneyTomCollinsWalterReedBunnySherman
LissiMarquisEd
JonesBillyRayeShelbyFooteWillyWonka)

register
SMK_create( )

| | |
|---|---|
| | post-processing |
| | SMK_get( ) |
| | bit instruction position 7 instructions |
| SecurityTokenMessage dataflow | 112-128 |

| | |
|---|---|
| | The states of the security level the servlet sees a |
| Device-User AccessState | client and client_device |

| | | |
|---|---|---|
| | | session,ipAddr, |
| | | Array_cookies |
| | Unknown Unauthorized | (nCommon) |
| UUU | User | uname(nCommon), |
| KUU | Known Unauthorized | min,sid, |
| | User | Array(nir(Networks |
| | | InRange), |
| | | ip,Array_cookies |
| AU | Authorized User | MID,SID,ArrayData |
| NDU | NetworkDataUser | API_Bit,ArrayData |
| APIU | APIUser | API_Bit,ArrayData |
| SU | SuperUser | (sessionless) |
| | | (all- any) |

| Device_on- Icon_mode | | |
|---|---|---|
| bitPos | meaning | stream |

| | | |
|---|---|---|
| social graph | | |
| functions | | 1 |
| | | 2 |
| | | 3 |
| | | 4 |
| | | 5 |
| | | 6 |
| | | 7 |
| | | 8 |
| | | 9 |
| | 10(A) | |
| | 11(B) | |
| | 12(D) | |
| | 13(D) | |
| | 14(E) | |
| | 15(F) | |
| Servlet Status | | 32 |
| (ACK) | | 33 |
| | | 34 |
| | | 35 |
| | | 36 |
| | | 37 |
| | | 38 |
| | | 39 |
| | | 40 |
| | | 41 |
| | | 42 |
| | | 43 |
| | | 44 |
| | | 45 |
| | | 46 |
| | | 47 |
| | | 48 |
| Graph registration- | | 49 |
| execution | | 50 |
| | | 51 |
| | | 52 |
| | | 53 |
| | | 54 |
| | | 55 |
| | | 56 |
| | | 57 |
| | | 58 |
| | | 59 |
| | | 60 |
| | | 61 |
| | | 62 |
| | | 63 |
| security | | |
| execution(MenuMode | | |
| only) | | 64 token_init |
| | | 65 StateAck |
| | | 66 ProviderRespond |
| | | 67 TrusteeMark |
| | | 68 TrusteeInit |
| | | 69 TrusteeSelect |
| | | 70 TrusteeAck |
| | | 71 ContentIdIndex |
| | | 72 ContentIdRespond |
| | | 73 ContentStoreAck |
| | | 74 UniqueIDAck |
| | | 75 Call2Datastore |
| | | 76 Call2Memstore |
| | | 77 PointerSet |
| | | 78 TokenIDSent |
| | | 79 TokenIDStored |
| | | 80 TokenExtend |

| | | |
|---|---|---|
| agent based model | [81-96] | future |
| unused | [97-111] | |

| | | |
|---|---|---|
| IconMode device | | |
| connect | 112 run_ping | API_bit,MID,SID,ArrayData |
| | 113 run_login | |
| | 114 run_update | |
| | 115 run_trigger | |
| | 116 unused | |
| | 117 unused | |
| | 118 unused | |
| | 119 trigger | API_bit,MID,SID |
| | 120 update | |
| | 121 unused | |
| | 122 unused | |
| | 123 unused | |
| | 124 unused | |
| | 125 unused | |
| | 126 unused | |
| | 127 unused | |
| | 128 unused | |

| | |
|---|---|
| unused | [129-143] |
| API data | [144++] |

The following definitions are examples meanings for the terms used in the above

Tables.

TABLE 3

| MetaName | Definition | Sample Data Stream |
|---|---|---|
| use case | uuu, kuu, au | |
| executing | | |
| names | names of people | Mark Puflea, Wiley Becker, Troy |
| | | Knaus, Greg Pool, David Letterman, |
| | | Rhonda Whitney, Tom Collins, Walter |
| | | Reed, Bunny Sherman, Lissi Marquis, |
| | | Ed Jones, Billy Raye, Shelby Foote, |
| | | Willy Wonka |
| min | mobile device id number | |
| sid | mobile device system id | |
| uid | nCommon user ID | |
| passwd | nCommon password | |
| servicematrixkey | internal key to bind profile content_pointers to a vertex | |
| vertex | a service factory value (pointer to all related nCommon | |
| | network storing the primary bivariate function linking | |
| | content data by geocode_view or social_graph_view | |
| heap | a service factory value (pointer to all related registers | |
| | under a servlet vertex_instance | |
| profile | a pointer to unique user index value from Facebook, | |
| | MySpace or LinkedIn. | |
| protocol | a pointer to a current execution protocol, process or | |
| | model running as a member of the vertex-associated | |
| | heap | |
| secmark | a pointer to a security marker | |
| nOrder | a pointer to profiles in range | |
| nAssoc | a pointer to associated profiles | |
| vertex | a derived address for the users register collection | |
| socialgraph | a polar plot of vertexes in one of two states (directed, or | |
| | undirected) as determined by the state of the active | |
| | messaging vertex. (similar to a router arping or | |
| | not_arping) | |

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

We claim:

1. A method comprising:
receiving a request for a security token from a requestor;
identifying, for the request, an executor and a trustee from social network contacts of the requestor;
generating, via a processing device, a challenge question based on location history information common to the requestor, the executor, and the trustee;
presenting the challenge question to the executor and to the trustee;
receiving an executor response from the executor and a trustee response from the trustee; and
when the executor response and the trustee response match, transmitting the security token to the requestor.

2. The method of claim 1, wherein the executor and the trustee are first order contacts to the requestor.

3. The method of claim 1, further comprising:
identifying a plurality of trustees;
presenting the plurality of trustees to the executor; and
receiving, from the executor, a selection of the trustee from the plurality of trustees.

4. The method of claim 1, wherein at least one of the executor or the trustee is identified based on the location history information.

5. The method of claim 1, wherein the executor response and the trustee response comprise at least one of audio, video, text, a gesture, an image, a date, a time, a direction, a number, a name, a price, and a color.

6. The method of claim 1, further comprising:
presenting the trustee response to the executor prior to receiving the executor response.

7. The method of claim 1, further comprising:
generating the challenge question further based on social networking data of at least one of the requestor, the executor, and the trustee.

8. The method of claim 7, wherein the social networking data comprises a social networking graph of social connections.

9. The method of claim 7, wherein the challenge question is generated based on a portion of the social networking data marked as public.

10. A system comprising:
a processor;
a memory having stored therein instructions which, when executed by the processor, cause the processor to perform a method comprising:
receiving a request for a security token from a requestor;
identifying, for the request, an executor and a plurality of trustees from social network contacts of the requestor;
generating respective challenge questions based on location history information common to the requestor, the executor, and each respective trustee of the plurality of trustees;
presenting each respective challenge question to the executor and to each respective trustee of the plurality of trustees;
receiving an executor response from the executor and respective trustee responses from at least some of the plurality of trustees; and
when the executor response and at least a threshold quantity of respective trustee responses match, transmitting the security token to the requestor.

12. The system of claim 10, wherein the executor and the trustee are first order contacts to the requestor.

13. The system of claim 10, further comprising:
presenting the plurality of trustees to the executor; and
receiving, from the executor, a selection from the plurality of trustees.

14. The system of claim 10, wherein at least one of the executor or the trustee is identified based on the location history information.

15. The system of claim 10, wherein the executor response and the trustee response comprise at least one of audio, video, text, a gesture, an image, a date, a time, a direction, a number, a name, a price, and a color.

16. A non-transitory computer-readable storage medium having stored therein instructions which, when executed by a processing device, cause the processing device to perform steps comprising:
receiving a request for a security token from a requestor;
identifying, for the request, an executor and a trustee from social network contacts of the requestor;
generating a challenge question based on location history information common to the requestor, the executor, and the trustee;
presenting the challenge question to the executor and to the trustee;
receiving an executor response from the executor and a trustee response from the trustee; and
when the executor response and the trustee response match, transmitting the security token to the requestor.

17. The non-transitory computer-readable storage medium of claim 16, the instructions, when executed by the processing device, further causing the processing device to perform steps comprising:
presenting the trustee response to the executor prior to receiving the executor response.

18. The non-transitory computer-readable storage medium of claim 16, the instructions, when executed by the processing device, further causing the processing device to perform steps comprising:
generating the challenge question further based on social networking data of at least one of the requestor, the executor, and the trustee.

19. The non-transitory computer-readable storage medium of claim 18, wherein the social networking data comprises a social networking graph of social connections.

20. The non-transitory computer-readable storage medium of claim 18, wherein the challenge question is generated based on a portion of the social networking data marked as public.
